(19) United States
(12) Patent Application Publication
(10) Pub. No.: US 2008/0154860 A1
(43) Pub. Date: Jun. 26, 2008

(54) EFFICIENT PROCESSING OF TREE PATTERN QUERIES OVER XML DOCUMENTS

(75) Inventors: Songting Chen, San Jose, CA (US); Hua-Gang Li, San Jose, CA (US); Junichi Tatemura, Sunnyvale, CA (US); Wang-Pin Hsiung, Santa Clara, CA (US); Divyakant Agrawal, Goleta, CA (US); Kasim Selcuk Candan, Tempe, AZ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/691,470

(22) Filed: Mar. 26, 2007

Related U.S. Application Data
(60) Provisional application No. 60/804,673, filed on Jun. 14, 2006.
(60) Provisional application No. 60/804,667, filed on Jun. 14, 2006.
(60) Provisional application No. 60/804,669, filed on Jun. 14, 2006.
(60) Provisional application No. 60/868,824, filed on Dec. 6, 2006.

(51) Int. Cl. G06F 17/30

(52) U.S. Cl. 707/3; 707/E17.014

(57) ABSTRACT

Systems and methods process generalized-tree-pattern queries by processing a twig query with a bottom-up computation to generate a generalized tree pattern result; encoding the generalized tree pattern results using hierarchical stacks; enumerating the generalized tree pattern result with a top-down computation; a hybrid of top-down and bottom-up computation for early result enumeration before reaching the end of document; and a more succinct encoding scheme that replaces the hierarchical stacks to further improve the performance.

This application claims priority to Provisional Application Ser. Nos. 60/804,673 (filed on Jun. 14, 2006), 60/804,667 (filed on Jun. 14, 2006), 60/804,669 (filed on Jun. 14, 2006), and 60/868,824 (filed on Dec. 6, 2006), the contents of which are incorporated by reference.

### BACKGROUND

This invention relates to processing of tree pattern queries over XML documents.

XML (Extensible Markup Language) is a tool for defining, validating, and sharing document formats. XML uses tags to distinguish document structures, and attributes to encode extra document information. An XML document is modeled as a nested structure of elements. The scope of an element is defined by its start-tag and end-tag. XML documents can be viewed as ordered tree structures where each tree node corresponds to document elements and edges represent direct (element->sub-element) relationships. The XML semi-structured data model has become the choice both in data and document management systems because of its capability of representing irregular data while keeping the data structure as much as it exists. Thus, XML has become the data model of many of the state-of-the-art technologies such as XML web services. The rich content and the flexible semi-structure of XML documents demand efficient support for complex declarative queries.

Common XML query languages, such as XPath and XQuery, issue structural queries over the XML data. One common structural query is tree (twig) pattern query. A sample tree pattern query is shown in FIG. 1B over the example XML document tree in FIG. 1A. The “/” axis denotes the Parent-Child (PC) relationship, while the “//” axis denotes the Ancestor-Descendant (AD) relationship. Here a document element a can be a match to query node A when it has path matches for both //A/B//D and //A/B/C.

The matching of tree pattern queries over XML data is one of the fundamental challenges for processing XQuery. Most existing works on processing twig queries decompose the twig queries into paths and then join the path matches. This approach may introduce very large intermediate results. Consider the sample XML document tree in FIG. 1A and a tree pattern query in FIG. 1B. The path match (a1,b4,d4) for path //A/B//D does not lead to any final tree pattern match since there is no child C element under b4. To solve this problem, holistic twig pattern matching has been developed in order to minimize the intermediate results, i.e., only to enumerate those root-to-leaf path matches that will be in the final twig results. However, when the twig query contains parent child relationship, these solutions may still generate useless path matches.

Yet another challenge is that in order to process the more complex XPath and XQuery statements, a more powerful form of tree pattern, namely, generalized twig pattern (GTP), is required to consider the evaluation of an XQuery as a whole to avoid repetitive work. As shown in FIG. 1C, GTP query may have solid and dotted edges, representing mandatory and optional structural relationships, respectively. The mandatory semantics corresponds to those path expressions in the FOR or WHERE clauses. The optional semantics corresponds to those path expressions in the LET or RETURN clauses. For a given GTP, not all nodes are return nodes. For the path expressions in the FOR clause, only the last node is the return node. One example is the B node of GTP1 in FIG. 1C. For the path expression in LET or RETURN clause, the matching elements may be grouped under their common ancestor element. One example is the C node of GTP2 in FIG. 1C.

These rich semantics introduce new challenges for handling the duplicates and ordering issues. In FIG. 1A, (i) for path query //B//D, assume B and D are both return nodes. The final matches are (b1,d1), (b2,d2), (b2,d3), (b3,d2), (b3,d3) and (b4,d4). (ii) Now assume D is the only return node. In this case, the results should be (d1),(d2),(d3) and (d4). Clearly, if the system were to generate the distinct path matches first as in the first case, duplicate elimination becomes unavoidable. (iii) Lastly, consider path query //A/B where $B is the only return node. The results are (b1), (b2), (b3) and (b4). This order is different from the order for the entire path matches, namely, (a1,b4), (a2,b2), (a3,b1) and (a4,b3).

In this system, well known region encoding for the XML document is used. FIG. 1A also includes the region encodings. Region encoding associates each XML document element with a 3-tuple [LeftPos, RightPos], Level. Here Level is the depth of the element in the document tree. LeftPos and RightPos are both integers. Given any two document elements, e1 and e2, e1 is e2's ancestor if and only if e1.LeftPos<e2.LeftPos and e2.RightPos<e1.RightPos. Furthermore, if e1.Level=e2.Level-1, then e1 is e2's parent. This encoding allows efficient structural checking between two document elements.

### SUMMARY

In a first aspect, a method to process generalized-tree-pattern queries includes processing a twig query with a bottom-up computation to generate a generalized tree pattern result; encoding the generalized tree pattern result with hierarchical stacks; and enumerating the generalized tree pattern result with a top-down computation.

Implementations of the above aspect may include one or more of the following. The system can process generalized-tree-pattern queries over XML streams. The system can process generalized-tree-pattern queries over XML tag indexes. The hierarchical stack can be an ordered sequence of stack trees. The stack tree can be an ordered tree with each node being a stack. The system can associate each stack with a region encoding. The system can create a hierarchical structure among stacks when visiting document elements in a post-order (Twig²Stack). The creation of the hierarchical stacks can be done through merging. Multiple stack trees can be combined into one tree.

In another aspect, a method to process generalized-tree-pattern queries include: for each document element e, pushing e into a hierarchical stack HS[E] if and only if e satisfies a sub-twig query rooted at query node E; and checking only E's child query nodes M, where all elements in HS[M] satisfy a sub-twig query rooted at M.

Implementations of the above aspect may include one or more of the following. The system can maintain a hierarchical stack structure using a merge algorithm when checking a query operation or when pushing one document element into the hierarchical stack. The system can encode twig results in order to minimize intermediate results. The system can enumerate generalized-tree-pattern results from compactly represented tree matches. Distinct child matches (and in document order) can be done in linear time for a non-return node in the generalized-tree-pattern query. The system can enumerate results of a generalized-tree-pattern query with interleaved return, group-return and non-return nodes. The system can combine top-down and bottom-up computation for a generalized tree pattern query. An early result enumeration scheme can be provided when elements in a top branch node's top-down stack have been popped out. An encoding scheme such as matching tree encoding can be used to replace the hierarchical stack by using a list of matching trees. The system can create a compact matching tree encodings through a hybrid of top-down and bottom-up computations. One or more child matching tables and one descendant matching table can be associated for each element in the top-down stack. The system can propagate the matching tree encodings to one of: a parent element child matching table, a descendant matching table.

The advantages of this invention include the following. The system uses a hierarchical stack encoding scheme to compactly represent the partial and complete twig results. The system then uses a bottom-up algorithm for processing twig queries based on this encoding scheme. The system efficiently enumerates the query results from the encodings for a given GTP query. Overall, the system efficiently processes GTP queries by avoiding any path join, sort, duplicate elimination and grouping operations. The system further uses an early result enumeration technique that significantly reduces the runtime memory usage. Finally, a more compact encoding method is used that avoids creating any hierarchical stacks. Experiments show that the system not only has better twig query processing performance than conventional algorithms, but also provides more functionality by processing complex GTP queries.

### BRIEF DESCRIPTION OF THE DRAWINGS

FIG. 1A shows a sample XML document tree.

FIG. 1B shows an exemplary tree pattern query.

FIG. 1C shows an exemplary GTP query with solid and dotted edges representing mandatory and optional structural relationships.

FIG. 2 shows an exemplary process to efficiently process GTP queries over XML documents.

FIG. 3A shows a running example of the process of FIG. 2 on an exemplary stack tree ST where each tree node is a stack S.

FIG. 3B shows an exemplary merge operation on the stack tree.

FIG. 3C shows one embodiment of a query node matching process.

FIG. 4 shows an exemplary merge process.

FIG. 5A depicts an exemplary optimization based on the XML document and query in FIG. 3A.

FIG. 5B shows an embodiment of a process for enumerating tree pattern matches from hierarchical stacks.

FIG. 6A shows an example of sorting a document order.

FIG. 6B shows an exemplary process to compute the total effect of ordering the documents.

FIG. 6C illustrates an exemplary process for early result enumeration.

FIG. 6D depicts an example for the query and XML document in FIG. 3A.

FIG. 7 shows exemplary statistics of the incorporated datasets including the document size, total number of elements, and the maximum and average depth.

FIG. 8 shows exemplary twig queries used for the experimental evaluation.

FIGS. 9-14 show exemplary results from the experimental evaluation.

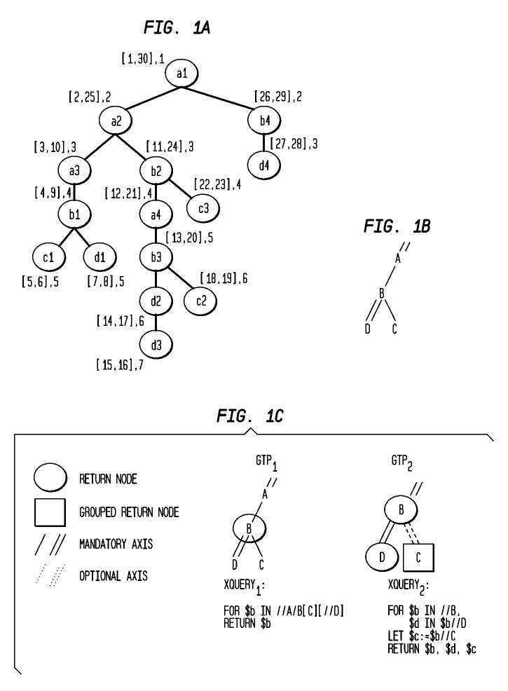

### DESCRIPTION

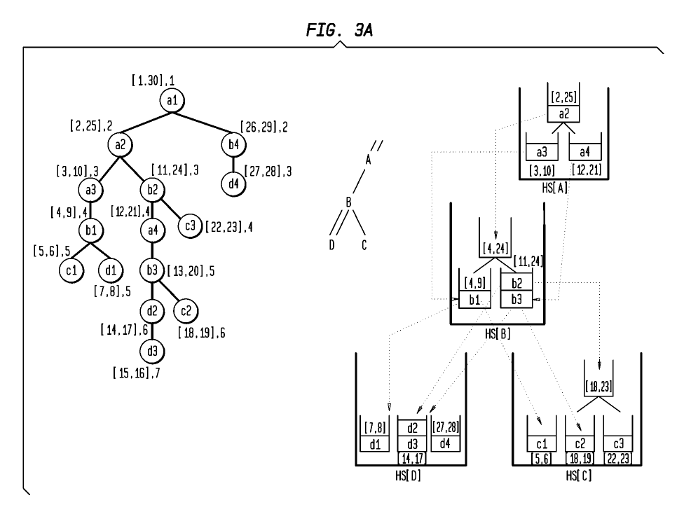

The tree pattern matching process uses a hierarchical stack encoding scheme which captures the ancestor descendant (AD) relationships for the elements that match the same query node. Each query node N of a twig query Q is associated with a hierarchical stack HS[N]. Each hierarchical stack HS[N] consists of an ordered sequence of stack trees ST. A stack tree ST is an ordered tree where each tree node is a stack S. For example, in FIG. 3A, HS[A] contains one stack tree, while HS[D] contains two stack trees. Each stack S contains zero or more document elements. The AD relationship between the document elements in a stack tree ST is implicitly captured as follows: one document element is an ancestor for all elements below in the same stack and is also an ancestor for all elements in its descendant stacks. Note that any two elements have no AD relationship if their corresponding stacks have no AD relationship. In HS[A] of FIG. 3A, a2 is ancestor for both a3 and a4, while a3 and a4 have no AD relationship. In order to create the hierarchical structure among stacks when visiting the document elements in the post-order, each stack S is associated with a region encoding, similar to that for a document element. The LeftPos for a stack S is defined as the smallest Left-Pos among all the elements in stack S and all of S's descendant stacks. The RightPos for a stack S is defined as the largest Right-Pos among all the elements in stack S and all of S's descendant stacks. For instance, in FIG. 3B, the top stack of HS[A] has region encoding [3, 21], where 3 is the smallest LeftPos and 21 is the largest RightPos among its descendant elements. The region encodings for other stacks are shown in the figure. Next, the region encoding for a stack tree ST is the same as the encoding of ST's root stack. Finally, for a given hierarchical stack HS[N], its stack trees are ordered based on their RightPos. For a given stack S, its child stacks are also ordered based on their RightPos.

Given a document element e, the system pushes e into a hierarchical stack HS[E] (with the matching label, i.e., either the same label or wildcard ‘*’) if and only if it satisfies the sub-twig query rooted at this query node E. Only E's child query nodes M need to be checked due to the fact that all elements in HS[M] must have already satisfied the sub-twig query rooted at M. This enables a dynamic programming approach. Finally, the hierarchical stack structure is maintained using the merge algorithm either when checking one query step or when pushing one document element into the hierarchical stack. Maintaining the hierarchical structure among stacks impacts the efficient processing of twig queries and serves multiple purposes: 1) it encodes the partial/complete twig results in order to minimize the intermediate results; 2) it reduces the query processing cost as described below, and 3) it enables efficient result enumeration.

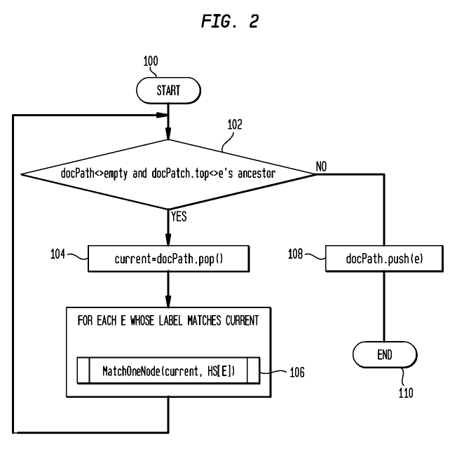

FIG. 2 shows an exemplary process 100 to efficiently process GTP queries over XML documents. First, the process checks if a document path is not empty and the top of the path is not the ancestor of the current element (102). If not, the element is then pushed back on the stack representing the document path (108), and the process exits (110). Alternatively, the process set the current element to the next item popped off the stack representing the document path (104). Next, for each query node whose label matches the top element of the document path, the process matches the node (106). One embodiment of the query node matching is shown in FIG. 3C. The following pseudo code corresponds to the algorithm shown in FIG. 2.

Procedure Twig2Stack(docElement e)
Stack docPath;
docElement current;
1. BEGIN
2. WHILE docPath not empty AND docPath.top is not e's ancestor
3. current = docPath.pop( );
4. FOR each query node E with matching label of docPath.top
5. MatchOneNode(current, HS[E]);
6. docPath.push(e);
7. END

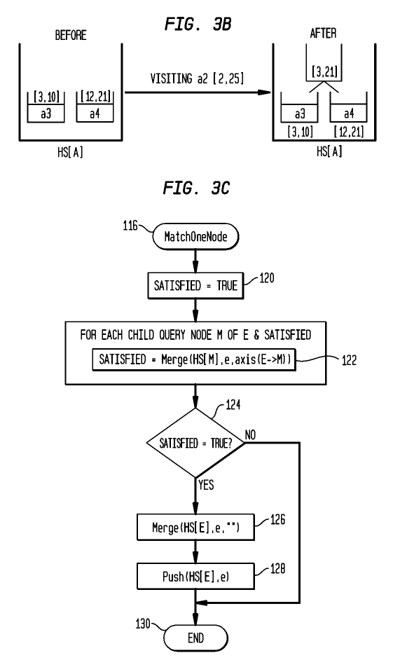

In FIG. 2, given a document element e visited in post-order, the process first checks if e can be pushed into its corresponding hierarchical stack HS[E] by using the node matching algorithm in FIG. 3C. First, a Satisfied flag is set (120). Next, for each child query node and as long as the Satisfied flag is true, the hierarchical stack is updated by a merging process (122). The Satisfied flag is updated during the merge operation. More details of one embodiment of the merging process are shown in FIG. 4. Next, if the Satisfied flag is true (124), the process merges the stack trees in HS[E] (126) and pushes e onto the stack HS[E] (128). From 124 or 128, the process exits (130). The following pseudo code corresponds to the algorithm in FIG. 3C.

Procedure MatchOneNode (docElement e, HierarchicalStack HS[E])
Boolean Satisfied;
1. BEGIN
2. Satisfied = TRUE;
3. FOR each child query node M of E & Satisfied
4. Satisfied = merge(HS[M], e, axis(E->M));
5. IF Satisfied
6. merge(HS[E], e, “”);
7. push (HS[E], e);
8. END

In this pseudo-code, once e satisfies all the axis requirements for query node E, e is pushed into the hierarchical stack HS[E]. Meanwhile, the system maintains the hierarchical structure of the elements in HS[E] by merging the stack trees in HS[E] based on e (line 6 in MatchOneNode algorithm) and push e to the top of the merged stack (line 7). Note that if there is no existing stack tree which is the descendant of e, then a new stack will be created to hold e. The optional axis in GTP can be supported by pushing an element into the stack if and only if all its mandatory axes are satisfied, while edges are created for both mandatory and optional children.

The aforementioned merge algorithm is depicted in FIG. 4, which shows one embodiment of a process 140 to create hierarchical stacks through merging. For each stack tree ST of HS[M], the following operations are performed. First, initial conditions are set (144). Next, the process checks if ST's right position is less than the left position of the element e (146). If not, the process exits. Otherwise the process further checks if the axis is the parent child (PC) axis and the level of the top of the stack is equal to the next level of the element (148). If so, the Satisfied flag is set (150) and the PC edge is added (152). If not, the process checks if the axis is the ancestor-descendant (AD) edge (154). If the axis is AD, the process sets the Satisfied flag (156) and adds an AD edge (158). From 152, 154 or 158, STS is set to equal a union of STS and ST. The foregoing operations are repeated for each stack tree ST. The process then creates the merged stack tree (162) and exits (164). The corresponding pseudo code of the Merge algorithm is shown below:

Boolean merge (HierarchicalStack HS[M], docElement e, Axis axis)
Boolean Satisfied = FALSE;
StackTreeSet STS = empty;
1.BEGIN
2. FOR each stack tree ST of HS[M] //Visit in descending order
of ST's RightPos
3. IF ST.RightPos < e.LeftPos
4. break; //No need to keep visiting more stack trees;
5. IF axis = PC AND ST.top.Level = e.Level+1
6. Satisfied = TRUE;
7. addPCEdge(e, M, ST.top);
8. ELSE IF axis = AD
9. Satisfied = TRUE;
10. addADEdge(e, M, ST.top);
11. STS = STS U ST;
12. createMergedStackTree(STS);
13. return Satisfied;
14.END

In this pseudo-code, createMergedStackTree (line 12) creates a new stack and lets all stack trees in STS (if more than two) be its children. Line 5-10 processes one query step. FIG. 3B depicts an example for this merge operation. In this exemplary Merge operation, during the post-order traversal of the XML document in FIG. 3A, the system visits a3, a4 and then a2. The hierarchical stack HS[A] before visiting a2 in FIG. 3B is on the left side. Node a2 is determined to be an ancestor of both stacks. The two stacks are merged by creating a new empty stack and having both existing stacks be its children.

FIG. 3A depicts a running example of the entire Twig2Stack algorithm. When visiting a2, the stack trees in HS[B] are merged while checking the PC axis (create one edge to b2). When visiting a1, the system checks the top element in HS[B] and HS[C].

In one embodiment providing optimization for non-return nodes in a GTP query, which is common in XPath or XQuery, the system optimizes space and computation costs. The system defines a query node N as an existence-checking node if and only if 1) N is not a return node and 2) there is no return node below N. When a query node N is an existence-checking node, only the root stack and its top element of each stack tree need to be retained. The reason is that, at any time, the parent query node only needs to check the top element (or root stack) and the existence of such a top element (or root stack) suffices. Hence, once the stack trees are merged, they are no longer useful. Also the system can avoid creating any edges to an existence-checking node.

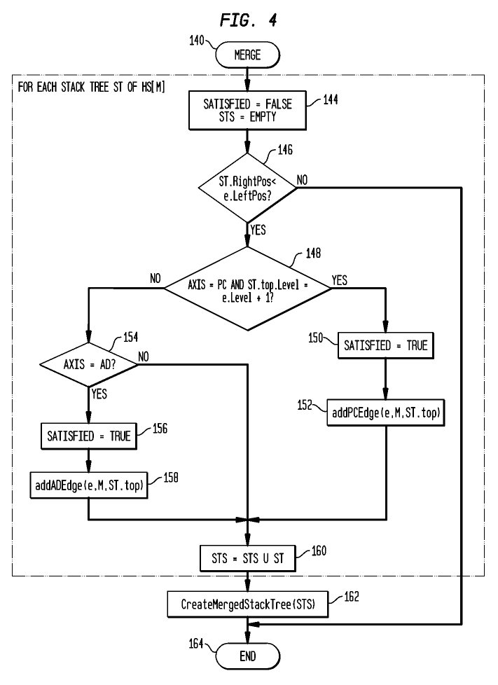

FIG. 5A depicts this optimization based on the XML document and query in FIG. 3A. B is the only return node. In this case, both C and D are existence-checking nodes. Note that A is not an existence-checking node although it is a non-return node. The reason is that the elements in HS[A] can not be thrown away since they serve as bridges to the return node B for result enumeration. For existence-checking nodes, such as C and D, any descendant stacks or non-top elements can be safely removed as the shaded rectangles shown in the figure. Also the process does not need to create any edges to C and D.

Next, an efficient solution to enumerate the query results for a GTP query is discussed that are duplicate free and preserve document order from the encodings. For simplicity, query results are not enumerated until the entire document has been processed by the Twig2Stack algorithm. One embodiment enumerates the results earlier and the space consumed by the hierarchical stacks can also be freed up.

Two functions, namely, pointAD(e, HS[M]) and pointPC(e,HS[M]), are defined next, where e is a match of E and M is one child node of E. pointPC(e,HS[M]) returns all the elements in HS[M] that satisfy the PC relationship with e, while pointAD(e, HS[M]) returns all the elements in HS[M] that satisfy the AD relationship with e. pointPC is the same as the edges created by the merge algorithm in FIG. 4. pointAD is computed by expanding the edges created by the merge algorithm. Such expansion simply returns all the descendant elements with respect to one edge. For example, FIG. 3A shows pointPC(a2, HS[B])={b2}, pointPC(a3, HS[B])={b1} and pointAD(b1, HS[D])={d1}, pointAD(b2, HS[D])={d2,d3}.

When dealing with a GTP which may contain non-return nodes, duplicate and out-of-order results may occur. Such phenomena can be easily explained under the hierarchical stack encoding scheme. In FIG. 3A, if D is a return node. At this stage, pointAD(b2, HS[D])={d2,d3} and pointAD(b3, HS[D])={d2,d3}. The latter generates only duplicates. In this case, b3 is descendants of b2. Second, assume that only B is a return node, pointPC(a2, HS[B])={b2}, pointPC(a3, HS[B])={b1} and pointPC(a4,HS[B])={b3}, while the correct return order should be {b1, b2, b3}. This output order is no longer consistent with the order of their parents. In this case, b2 is an ancestor of a4 and is thus an ancestor of any elements in pointPC(a4, HS[B]). The above example shows that the duplicate problem occurs when the two elements with AD relationship point to the same descendant element, while the out-of-order problem occurs when the two elements with AD relationship point to their respective child elements that no longer preserve order. If the system maintains the elements returned by pointPC and pointAD in an ordered (in pre-order) sequence of trees (SOT) structure, i.e., maintain their structural relationships, the duplicate and out-of-order problems can be solved. The hierarchical structure between elements is already preserved in the hierarchical stack and can be cheaply produced.

The results are enumerated reversely compared to the computation. This way, the system only visits these elements that are in the final results. The algorithm enumerates the results for a given GTP query, which may contain both return nodes and non-return nodes. The GTP results are returned in a tuple format. That is, each column corresponds to one return node and stores the matching document element ID. When a query node is a group return node, then a list of matching elements' ID is stored. When a query node is optional, the column value may be null. It is also easy to return the GTP results in tree format or include value, attribute information.

FIG. 5B shows an embodiment for enumerating tree pattern matches from hierarchical stacks (EnumTwig2Stack). In process 170, the process checks for a return node below E (172). If not, the process returns an end of stack indication as there is no need to traverse the stack (174). Alternatively, the process checks if E is the return node (176). If so, then for each element e, the process first sets the branch result to EMPTY (180) and then computes the total effect (mSOT) for each E's child query node M (192). The branch result is set to equal a Cartesian Product between the branch result and a recursive call of EnumTwig2Stack over mSOT (194). After all the child query nodes M are visited, the total result is then set to be a union of the total result with the branch results whose E column is set to e (196). The total result is returned until all the elements in eSOT are visited (198). If E is not the return node, the process sets mSOT to contain the result of computing the total effect (200) and returns the result of a recursive call to EnumTwig2Stack (M, mSOT) (202) and the process exits (204). The corresponding pseudo code of EnumTwig2Stack Algorithm is as follows:

GTPResult EnumTwig2Stack (queryNode E, SOT eSOT)
GTPResult totalResult = branchResult = empty;
SOT mSOT;

| | |
|---|---|
| 1. | BEGIN |
| 2. | IF no return node below E |
| 3. | return convert2Tuple(eSOT); //No need to further traverse down |
| 4. | ELSE //there is return node below E, need to traverse down |
| 5. | IF E is return node |
| 6. | FOR each element e in eSOT //Visit each tree in eSOT in pre-order |
| 7. | branchResult = empty; |
| 8. | FOR each E's child query node M, with M not being existence-checking node |
| 9. | mSOT = computeTotalEffect(e, axis(E->M), HS[M]); |
| 10. | branchResult = branchResult × EnumTwig2Stack(M, mSOT); |
| 11. | totalResult = totalResult UNION setColumn(e, branchResult); |
| 12. | return totalResult; |
| 13. | ELSE // E is non-return node |
| 14. | mSOT = computeTotalEffect(eSOT, axis(E->M), HS[M]); |
| 15. | return EnumTwig2Stack(M, mSOT); |
| 16. | END |

Initially, the stack trees in the query root node represent an SOT structure and serve as a starting point of the enumeration algorithm. For example, the SOT for the root query node A in FIG. 3A is the tree of a2, a3, a4. When traversing down the query nodes, if current query node E is a return node, then the system needs to repetitively traverse down the query nodes for each element in the SOT (line 6). The reason is that each of these elements will lead to some distinct answers. If this query node is also a branch node, a Cartesian product is done of all the sub-twig results from different branches (line 9). Here setColumn(e,BranchResult) in line 10 sets the E column as e for all the tuples in BranchResult. When current query node E is a non-return node, instead of traversing down the query nodes for each element in E's SOT, the system computes the total effects of these elements on E's non-existence-checking child node M. Finally, when the system reaches the leaf node, the system converts the resulting SOT into tuples (line 3). In particular, if it is a return node, then the system creates one tuple for each element in SOT by visiting each tree in the pre-order. If it is a group return node, then the system just creates one tuple with the column value being a list grouped by all the elements in SOT. Note that it is straightforward to support aggregate functions over the group return node.

As mentioned when handling a non-return node E, the system computes the total effects of a set of elements in HS[E] on its child HS[M]. Assume a non-return query node E and its child query node M. For a given set of elements eSOT in HS[E] maintained in sequence of trees (SOT) format, the system computes its total effects on the query node M, namely, a set of elements resultSOT in HS[M] maintained also in SOT format, with each element in resultSOT having at least one element in eSOT that satisfies the query step E->M. When the query step E->M is an AD relationship, obviously only the root element of each tree in eSOT needs to be considered. The final resultSOT is simply a union of all pointAD(root,HS[M]). All other elements in eSOT are guaranteed to only generate duplicates. When the query step E->M is a PC relationship, a simple way to handle the order problem is to sort the elements in pointPC(e,HS[M]) for all e in eSOT. In fact, sorting is not necessary since all the elements e in eSOT and their child m elements in pointPC(e,HS[M]) already preserved their respective document order by the Twig2Stack algorithm.

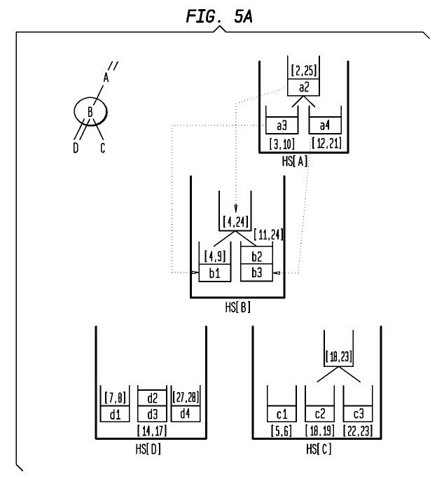

FIG. 6A provides a basic intuition regarding how this order problem can be resolved. Assume that one element e with children e1, . . . , en in an SOT tree and pointPC(e,HS[M]) equals m1, . . . , mp. Both e1, . . . , en and m1, . . . , mq are sorted in the document order which can be easily guaranteed by Twig2Stack algorithm. Starting from e1 and m1, three possible positions for m1:
(1) m1 is on the left side of e1. In this case, m1 is added into result-SOT since there will be no other result element that appears before m1 in the document order or is a descendant of m1;
(2) m1 is an ancestor of e1. In this case, m1 must also be an ancestor for all pointPC(e1,HS[M]) and all pointPC(e′,HS[M]), where e′ is any descendant of e1 in eSOT. If the total effects of e1 and all its descendant elements e′ is recursively computed as SOT1, a new SOT tree will be created with m1 being the root and SOT1 being its children.
(3) m1 is on the right side of e1. In this case, the total effects of e1 and all its descendant elements e′ are added into resultSOT. Since both lists are ordered, the system scans them only once.

FIG. 6B shows an exemplary process 220 to compute the total effect. For each tree, the process checks if the axis is AD (222). If so, the result is set to a union of all the matching elements that each root element points to (224). Alternatively, the process identifies the matching elements (mSOT) that the root points to (228). The child elements (childElements) are set to root's children (230). Next, while mSOT still has more elements (240), the process gets the next m in mSOT (250). While the next child element e's right position is less than the left position of m, the process keeps union resultSOT with the matching elements that e points to (252). After that, subSOT is set to EMPTY (254). Then, while there are more child elements e, and e is descendant of m (260), the process unions subSOT with the matching elements that e points to. After that, the process unions the resultSOT with a tree, where the root is m and subSOT is m's children. (264). Once mSOT becomes empty, the process unions resultSOT with all the matching elements that the rest of the child elements point to (270). The process returns resultSOT as the output (280) and exits (290). In essence, the process of FIG. 6B provides an efficient algorithm for computing total effects that are duplicate-free and preserve document order without introducing a post-duplication elimination or post-sort operation. The corresponding pseudo code is as follows:

SOT computeTotalEffect(SOT eSOT, Axis axis, HierarchicalStack HS[M])
//Assume eSOT contains a sequence of trees t[1..p]
SOT resultSOT = mSOT= subSOT=empty;
docElement childElements[ ], e, m;

| | |
|---|---|
| 1. | BEGIN |
| 2. | FOR each tree t[i] in eSOT |
| 3. | IF Axis = AD |
| 4. | resultSOT = resultSOT UNION pointAD(t[i].root, HS[M]); |
| 5. | ELSE //Axis = PC |
| 6. | mSOT = pointPC(t[i].root, HS[M]); //child elements m that t[i].root points to |
| 7. | childElements = t[i].root.children( ); //t[i].root's children in tree t[i] |
| 8. | WHILE [symbol] mSOT |
| 9. | m = mSOT.next( ); |
| 10. | WHILE e = childElements.next( ) and e.RightPos < m.LeftPos |
| 11. | resultSOT = resultSOT UNION computeTotalEffect(e, axis, HS[M]); |
| 12. | subSOT = empty; |
| 13. | WHILE e = childElements.next( ) and m.[LeftPos,RightPos] in e.[LeftPos,RightPos] |
| 14. | subSOT = subSOT UNION computeTotalEffect(e,axis, HS[M]); |
| 15. | resultSOT = resultSOT UNION tree(m, subSOT); |
| 16. | WHILE e = childElements.next( ) |
| 17. | resultSOT = resultSOT UNION computeTotalEffect(e,axis, HS[M]); |
| 18. | RETURN resultSOT; |
| 19. | END |

In this pseudo-code below, tree(m, subSOT) in line 15 is to create a new tree with m being the root and all the trees in subSOT being its children. In one exemplary operation, if A is a non-return node in FIG. 3A, the SOT for HS [A] contains one tree with a2 being the root and a3, a4 being its children. The total effects of these three elements on B contains two trees, namely, (b1) and (b2, b3) with b2 being b3's parent (since b2 is ancestor of a4 and pointPC(a4, HS[B])=b3). The total effects of (b2, b3) on D contains one tree, namely, (c1, c2). In this case, only pointAD(b2,HS[D]) needs to be considered.

The following are two examples for the complete enumeration algorithm. Assume that A, B and D are the return nodes in FIG. 3A. For each of the elements a2, a3 and a4 (in that order), the system needs to traverse down the query nodes. Now assume only D is a return node. First, since A is not a return node, the system computes the total effects of A's SOT tree (a2,a3,a4) on B as b1 and (b2,b3). Next, since B is also not a return node and the axis between B and D is an AD relationship, only the top elements of B's SOT trees need to be considered, i.e., b1 and b2. Finally, the result tuples are (d1), (d2) and (d3). This is much better than first enumerating 9 path matches and then merge-joining (or semi merge-joining) these path matches and finally applying duplicate elimination/sort operation.

The Twig2Stack algorithm described in FIG. 2 employs a pure bottom-up approach. Note that a hybrid approach is possible that integrates both top-down and bottom-up methods. In particular, an algorithm known as PathStack is used for top-down computation and use Twig2Stack for bottom-up computation. More specifically, for any element e, it is pushed into the hierarchical stack HS[E] if and only if it satisfies the sub-twig query rooted at E as well as the prefix path query from root to E. To implement the above idea, each query node E is associated with two stacks, one for PathStack, S[E], one for Twig2Stack, HS[E], respectively. A document element e visited in pre-order is first pushed into the top-down stack S[E] based on PathStack algorithm. Once e is popped out from the top-down stack S[E] (post-order), the system pushes it into the hierarchical stack HS[E]. Note that PathStack is a quite efficient algorithm, i.e., O(1) for pushing or popping an element. Hence, the extra cost is small while the benefit can be significant since the condition for pushing elements into hierarchical stacks become more stringent. Another key advantage for this hybrid approach is that the system can enumerate the query results earlier and all the data in the hierarchical stacks can be cleaned up. This will greatly reduce the memory requirement.

Assume that the top branch node in a GTP query is E. Whenever the elements in S[E], i.e., the top-down stack, are all popped out, the system can start to enumerate the query results and then clean up all the hierarchical stacks. The following example in FIG. 6C illustrates the main idea of this early result enumeration mechanism.

The system re-uses the query and the data in FIG. 3A. The top branch node for this query is B. In hybrid query processing mode, when b1 is popped out of the top-down stack S[B] and pushed into the hierarchical stack HS[B] (the leftmost portion of FIG. 6C), the system can start to enumerate the query results. Here the solid edge denotes the edge used for PathStack, while the dotted edge denotes the edge used for Twig2Stack. The result enumeration algorithm is also a hybrid of PathStack and Twig2Stack enumeration algorithms, which is quite straightforward. After the result enumeration, the data in the hierarchical stacks can be removed. Intuitively, this is due to the fact that the sub-tree of b1 will not appear in any future results. There might raise a potential blocking issue whether the enumerated results can be output immediately. Here when A is not return node, then the system can output the enumerated results right away. When A is return node, however, the a3 results need to be kept in the temporary space (disk) until all a1 (and then a2) results are enumerated out. Similar issue exists for PathStack and can be resolved without sorting. The middle portion of FIG. 6C depicts the status when b2 is popped out from the top-down stack S[B]. In this case, although a4 has been popped earlier and there are some matches to the entire twig query, the system cannot clean up hierarchical stacks, because these data may lead to new matches for b2. The system can only clean up the hierarchical stacks when b2 is popped out. The rightmost portion shows the status when b4 is popped out from the top-down stack. Clearly, this early result enumeration mechanism can greatly reduce the memory requirement.

Finally, a more succinct encoding scheme is used to replace the hierarchical stacks. A matching tree can be either a single element e, or an inclusive tree [e], or a non-inclusive tree (e). Each element n in the top-down stack S[N] is associated with several child matching tables, one for each of N's child query nodes. If the axis between N and its parent node is AD, then an additional descendant matching table for n is needed which records the descendant elements of n that also satisfy this query node N. All these tables contain a list of matching trees mentioned above. Here is the algorithm that replaces the hierarchical stacks using this more compact encoding scheme.

Now assume N's parent node is M and the top element in S[M] is m. The top element in S[N] is n and the next one is n′. The parent element p of n is n′ if n′ is descendant of m. Otherwise p=m. When n is visited in post-order, it is satisfied to the sub-tree query rooted at N if and only if all its child matching tables are not empty.

1) If n is satisfied and M→N is PC axis, n will be added to the corresponding child matching table of m.

2) If n is satisfied and M→N is AD axis, n or [n] (depending on whether the descendant matching table of n is empty or not) will be added to p's child matching table (if p=m) or p's descendant matching table (if p=n).

3) If n does not satisfy N and M→N is AD axis, then the descendant matching table of n (could be (n) if the descendant matching table contains more than one tree) needs to be copied to p's child matching table (if p=m) or p's descendant matching table (if p=n′) as well.

Finally, the child matching tables of n with AD axes (could be (n) if the child matching table contains more than one tree) will be reported to the corresponding child matching tables of n′ or the descendant matching tables of the top element in the corresponding lower stack depending on which one is closer to n.

FIG. 6D depicts the example for the query and XML document in FIG. 3A. As can be seen, when b1 is visited in post-order, both of its matching tables are not empty. So b1 satisfies the sub-tree query rooted at B. b1 is then inserted into a3's child matching table. When visiting d3, it satisfies D. Since the parent axis is AD, d3 is inserted into b2's descendant matching table. When visiting d2, a compact form [d2] will be inserted into b3's child matching table, denoting that both d2 and its descendant elements match D. The rest of this figure is self-describing. The benefit of this modification is that the cost of creating hierarchical stacks can be completely avoided. Furthermore, the memory issue can be resolved as well, since the long child matching tables and descendant matching tables can be dumped into disk or early aggregation can be performed.

Next, experimental setup and results are discussed. The Twig2Stack algorithm was implemented using Java 1.4.2 on a PC machine with a Pentium M-2 GHz processor and 2 GB of main memory. Twig2Stack was compared with two other twig join algorithms: TwigStack and TJFast (both also implemented in Java)—TJFast has the best performance in terms of I/O cost and CPU time among the existing twig join algorithms, while TwigStack is the classical holistic twig join algorithm.

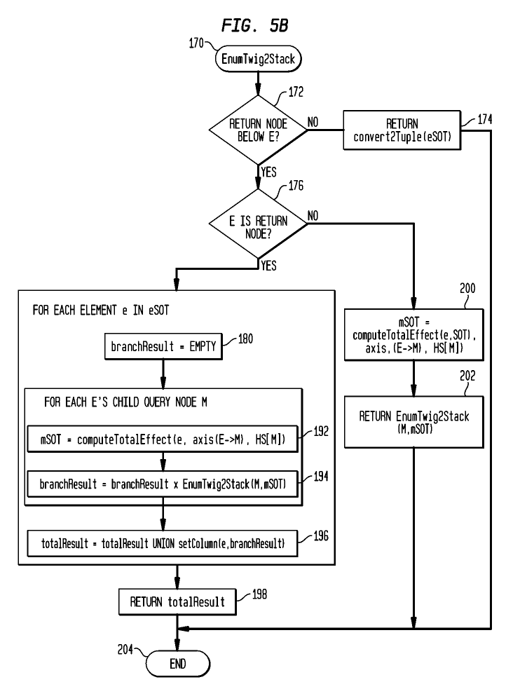

A set of synthetic and real datasets are used for the experimental evaluation. They are chosen since they represent a wide range of XML datasets in terms of the document size, recursion and tree depth/width. In particular, the synthetic datasets include XMark and Book generated by ToXGene using the book DTD from XQuery user case. The scaling factors of 1 to 5 were selected to generate a set of XMark synthetic datasets for the size scalability analysis of different twig join algorithms. The DTD for the Book XML dataset is a recursive one. ToXGene provides a fine granularity of recursion control when generating the XML documents so that the system can investigate how recursion affects the performance of different twig join algorithm. The two real datasets include DBLP and TreeBank. The DBLP dataset is a wide and shallow document, while the Tree-Bank dataset is a narrow and deep document. FIG. 7 depicts the statistics of the incorporated datasets including the document size, total number of elements, and the maximum and average depth.

The three twig join algorithms were compared in terms of the query processing time and the total execution time. For Twig2Stack, it is the time to perform the merging of hierarchical stacks, pushing elements to the stacks, and the result enumeration. For TwigStack, it is the time to perform computing and enumerating path matches, and finally merge-joining the path matches. For TJFast, it is the time to perform analysis of the extended dewey ID of the leaf element to infer its ancestors' label, enumerating path matches, and finally merge-joining the path matches.

The total execution time is the query processing time plus the scanning cost of the document elements. The scanning cost is basically IO cost. For both TwigStack and Twig2Stack, their scanning costs are the same, namely, for accessing the document elements corresponding to all query nodes. For TJFast, the scanning cost is for accessing the document elements corresponding to only those query leaf nodes. Hence, TJFast accesses fewer number of document elements, while the size per element may be larger since extended dewey ID for leaf elements typically is larger than region encoding.

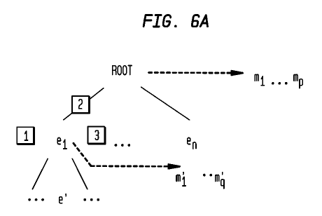

FIG. 8 shows all the twig queries used for the experimental evaluation. For each data set, three twig queries are selected (one for Book due to its very small DTD), which have different twig structures and combinations of parent-child and ancestor-descendant relations. Also they are selected to have different selectivity over the datasets.

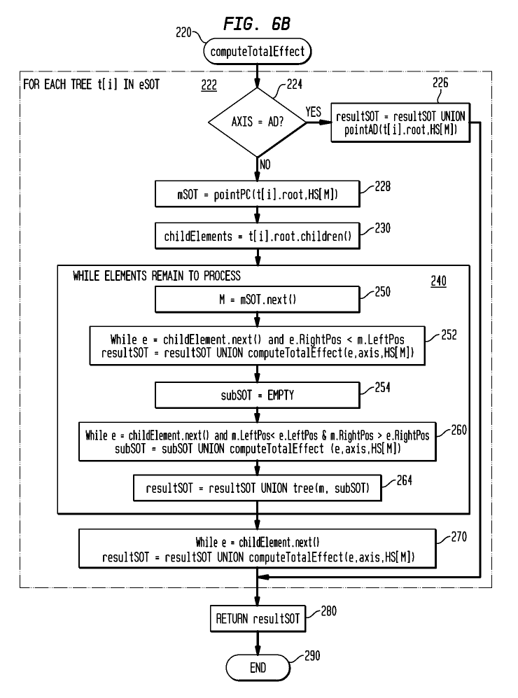

Next, Full Twig Query Processing performance is benchmarked. In this section, Twig2Stack is compared with TwigStack and TJFast for processing the full twig query (all query nodes are return nodes). FIG. 9 depicts the performance results based on the twig queries in FIG. 8 on DBLP, XMark (scale 1) and Treebank datasets in FIG. 7. For each twig query, the system recorded the query processing time, total execution time and IO time for all three algorithms.

DBLP Dataset: FIG. 9.(a) reports the query processing time, (b) reports the total execution time and (c) reports the IO time. Twig2Stack achieves one order of magnitude performance gain over TwigStack, and is two to three times faster than TJFast in terms of the query processing time. A detailed cost breakdown shows that this is primarily due to the fact that Twig2Stack avoids generating any path matches. Actually, the enumeration of path matches is non-trivial, even when all the generated path matches are in the final results. The reason is that enumerating path matches requires either traversing the PathStack for TwigStack or analyzing the extended dewey ID using the DTD transducer for TJFast. The same element may also exist in many path matches, resulting in duplicated efforts. In comparison, although Twig2Stack may also push a document element e into the hierarchical stack HS[E] with e potentially not being in the final twig results, the cost of merging HS[E] and all its child hierarchical stacks is not wasted. The reason is that they reduce the query processing cost, i.e., merging cost, for the remaining elements. The total execution time of Twig2Stack and TJFast is closer as depicted in FIG. 9 (b). The reason can be explained in FIG. 9 (c), i.e., TJFast saves more IO cost since it only needs to access the elements corresponding to the leaf query nodes. Note that, in this embodiment of the Twig2Stack algorithm is dedicated for optimizing the twig query processing cost and Twig2Stack can be extended to further reduce the IO cost. One approach creates a variant of B+ tree index on the document elements so that Twig2Stack can skip scanning the elements that cannot satisfy the query steps. A similar approach, called XB-tree, can be quite effective. On the other hand, for TJFast, accessing only the elements corresponding to the leaf query nodes is not always sufficient when the system evaluates or returns the values or attributes of the non-leaf query nodes. This would require accessing the elements corresponding to the non-leaf query nodes.

XMark Dataset: FIG. 9(d), (e) and (f) depicts the results on the XMark dataset with scale factor 1. For the query processing time of this data set, Twig2Stack again shows consistent order of magnitude performance gain over TwigStack and is several times faster than TJFast. A detailed cost breakdown shows the same reason, i.e., path enumeration. For the total execution cost of this dataset, TJFast introduces larger IO cost for Q3. Q3 in FIG. 8 contains three leaf query nodes with only one non-leaf query node. Hence, the saving on scanning the elements corresponding to one non-leaf query node is smaller than the cost paid for having a larger extended dewey ID per element.

TreeBank Dataset: FIGS. 9 (g), (h) and (i) depicts the results on the TreeBank dataset. For the query processing time, Twig2Stack again significantly outperforms TwigStack, and is two to three times faster than TJFast for Q1 and Q3. For Q2, since the selectivity of path matches is very low, only total 300 matches, the query processing time for Twig2Stack and TJFast becomes closer. The saving on IO cost for TJFast is bigger for this dataset. The reason is that the twig queries, especially Q2 has many distinct nonleaf query nodes. Meanwhile, since TreeBank is a narrow dataset, this means that the number of occurrences for even higher level elements is high, resulting in a large index size.

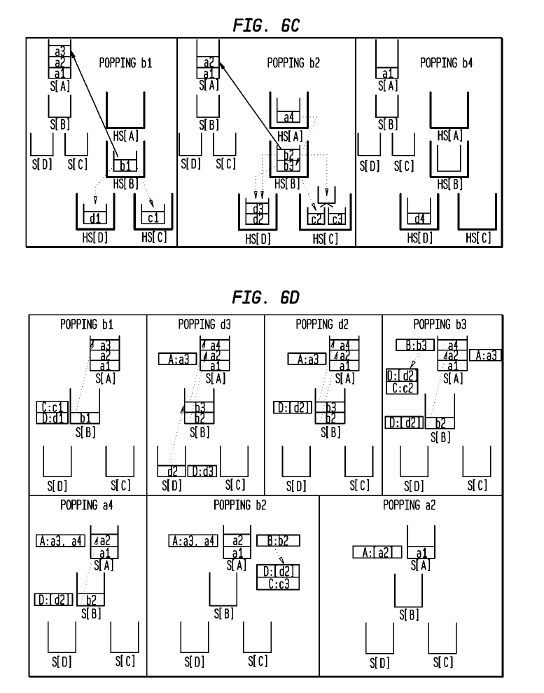

Book Dataset: FIGS. 10 (a), (b) and (c) depict the results on Book dataset. The x-axis is the average number of recursion on section element when generating the XML document. The results on query processing time are again similar to that of previous experiments. The deep recursion does not affect all three algorithms much, since they all have internal encoding mechanisms. For total execution time, TJFast introduces more IO cost when the document is deep, as large extended dewey IDs would have to be created. Meanwhile, since there are only two distinct non-leaf query nodes, the extra scanning cost for TwigStack or Twig2Stack is small.

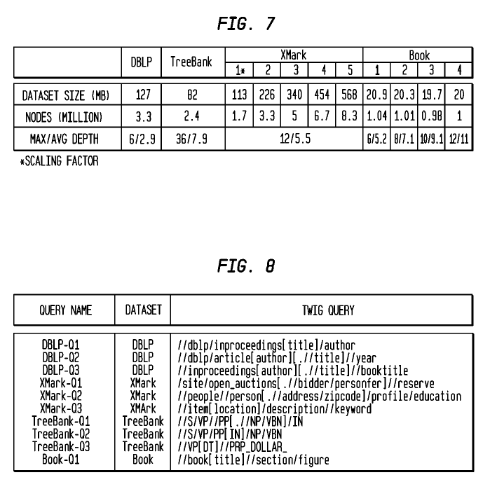

The scalability of Twig2Stack algorithm was investigated in terms of the size of the XML document. The XMark scale factor was varied from 1 to 5. FIG. 11 reports the results and as can be seen, all three algorithms grow linearly in terms of the document size. Twig2Stack again achieves significantly better query processing time.

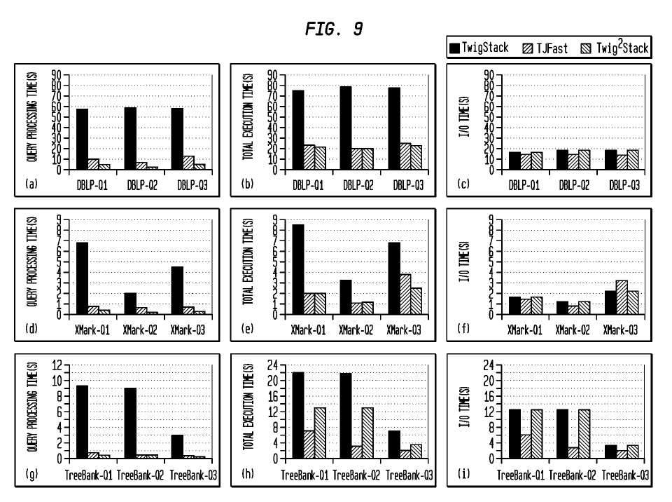

Next, the performance of Twig2Stack algorithm for processing GTP queries is discussed. GTP Queries over DBLP Dataset—DBLP-Q1 is used in FIG. 8 as the baseline twig query and then arbitrarily set some query node as non-return node or group return node. FIG. 12 depicts different GTPs and their respective query processing cost. Note that the IO cost is the same for all these GTPs. FIG. 12(a) is the baseline twig query with every node being a return node. (b) is a GTP query with title being a non-return node. In this case, the query processing cost for this GTP reduced compared to that for (a). The reason is that node title is an existence-checking node. In this case, maintaining the hierarchical structure in HS[title] can be avoided, i.e., only the top element and the root stack need to be kept. Also there is no need to create any edges from inproceedings element to title element. The result enumeration can also avoid to access HS[title]. (c) is a GTP query with author being a non-return node. In this case, the saving is even bigger since there are several authors per inproceedings while there is only one title per inproceedings in the DBLP dataset. Finally, (d) is a GTP query with author being a group return node. Compared to (b), where the only difference is the way how author is returned, (d) results in a much cheaper cost. The reason is that for (d), the system groups multiple authors to a list and only needs to create a single tuple, while for (b), the system creates one tuple per author.

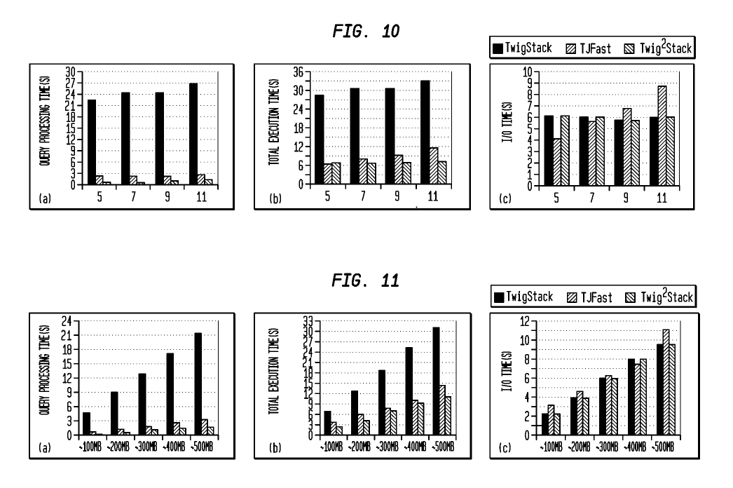

GTP Queries over XMark Dataset—XMark-Q1 in FIG. 8 is used as the baseline twig query and then arbitrarily set some query node as non-return node and set some axis as optional. FIG. 18 depicts different GTPs and their respective query processing cost. FIG. 13 (a) is the baseline twig query. (b) is a GTP query with address and zipcode being non-return nodes. In this case, the query processing cost for this GTP is reduced compared to that for (a). The reason is the same as before that the system can avoid maintaining the hierarchical structure in HS[address] and HS[zipcode], and avoid accessing them for result enumeration. (c) is a GTP query with only education being the return node. Compared to (b), although the system still has to maintain HS[people] and HS[person] since they have return node below, the final result size is reduced and so does the result enumeration cost. (d) is a GTP query with the axis between person and address being optional, while (e) is a GTP query in addition has the axis between profile and education being optional. In both cases, the number of twig matches is several times larger than that of (a), while the increase of query processing time is small. In comparison, optional semantics is often supported by using Left Outer-Join of path matches, while outer-join is already known to be in general more expensive than inner-join.

In sum, Twig2Stack provides a much better query processing cost compared to existing algorithms for full twig query processing. The experiments also demonstrate that Twig2Stack is fairly efficient for processing the more complex GTP queries, which may include non-return nodes, group return nodes and optional semantics. The performance results also show one interesting future extension, i.e., how to reduce the IO cost by scanning less document elements.

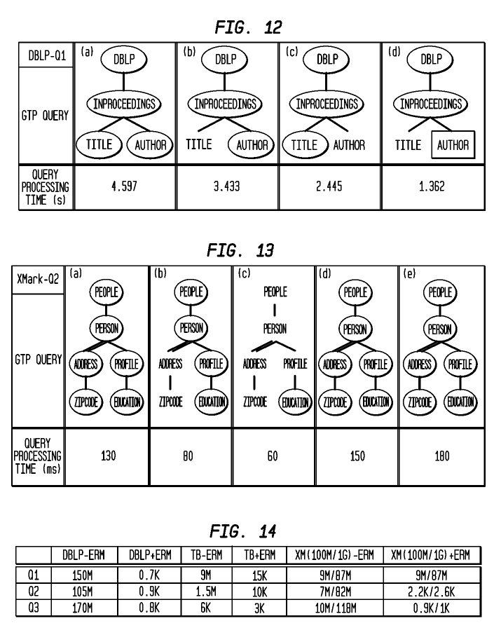

Finally, the memory usage for processing the above twig queries and how the early result enumeration technique helps to reduce the memory usage are discussed next. FIG. 14 depicts the memory usage for processing the twig queries in FIG. 8, with or without early result enumeration (ERM) enabled. First, consider DBLP dataset. The total memory consumptions for all three queries are quite high. This is due to the low selectivity of these queries. Basically, all the inproceedings (articles) are selected by those queries. Note that the memory usage is even bigger than the file size (127M) due to those pointers, a situation that has already been observed in main memory XML database. Note that when the early result enumeration technique is employed, the runtime memory usage is significantly reduced to less than 1 Kbytes. The reason is that as soon as one inproceedings (article) has been visited, the system can output the results and free up the memory. The memory requirement is thus bounded to the matches per inproceedings (article). Note that such matches are typically just related to the type of the document (e.g., from DTD) and is independent of the size of the document. Next, consider TreeBank (TB) dataset. TreeBank is a dataset with many distinct labels and with quite irregular structures. The selectivity is thus very high, which consequently results in low total memory usage even without early result enumeration enabled (compared to 82M document size). Nonetheless, early result enumeration reduces the runtime memory usage to just several Kbytes. Finally, consider XMark (XM) dataset. Two scale factors, s=1 (100 MBytes) and s=10 (1 GBytes) are used to generate the document. The total memory usage (without early result enumeration) grows as the scale factor increases for all three queries. Note that the early result enumeration becomes ineffective for Q1. From the query itself, its top branch node is open auctions. In XMark dataset, there is only one open auctions element which contains a huge number of open auction elements. This hints that a promising way to address this worst case memory problem is to find those query nodes which have a huge fan-out (subtree) in the document, and then effectively decompose the processing of individual branches (i.e., hybrid query plan). Next, the early result enumeration technique is very effective for handling Q2 and Q3, i.e., the runtime memory usage is independent of the document file size. Here the top branch nodes for Q2 and Q3 are person and item, respectively. Since the information contained in each person and in each item can typically be considered as constantly small, the runtime memory usage remains stably low. Further, the sample queries in XMark have been analyzed and among the total 20 queries, the top branch nodes are open auction, close auction, person and item, all of which are small trees. Hence, the early result enumeration technique likely would be useful for most practical queries.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to process generalized-tree-pattern queries, comprising:
processing a twig query with a bottom-up computation to generate a generalized tree pattern result;
encoding the generalized tree pattern result with hierarchical stacks; and
enumerating the generalized tree pattern result with a top-down computation.

2. The method of claim 1, comprising processing generalized-tree-pattern queries over XML streams.

3. The method of claim 1, comprising processing generalized-tree-pattern queries over XML tag indexes.

4. The method of claim 1, wherein the hierarchical stack comprises an ordered sequence of stack trees.

5. The method of claim 4, wherein the stack tree comprises an ordered tree with each node being a stack.

6. The method of claim 5, comprising associating each stack with a region encoding.

7. The method of claim 1, comprising creating a hierarchical structure among stacks when visiting document elements in a post-order (Twig²Stack).

8. The method of claim 7, comprising creating hierarchical stacks through merging.

9. The method of claim 7, comprising combining multiple stack trees into one tree.

10. A method to process generalized-tree-pattern queries, comprising:
for each document element e, pushing e into a hierarchical stack HS[E] if and only if e satisfies a sub-twig query rooted at query node E; and
checking only E's child query nodes M, where all elements in HS[M] satisfy a sub-twig query rooted at M.

11. The method of claim 10, comprising maintaining hierarchical stack structure using a merge algorithm when checking a query operation or when pushing one document element into the hierarchical stack.

12. The method of claim 10, comprising encoding twig results in order to minimize intermediate results.

13. The method of claim 1, comprising enumerating generalized-tree-pattern results from compactly represented tree matches.

14. The method of claim 13, comprising computing distinct child matches (and in document order) in linear time for a non-return node in the generalized-tree-pattern query.

15. The method of claim 13, comprising enumerating results of a generalized-tree-pattern query with interleaved return, group-return and non-return nodes.

16. A method to combine top-down and bottom-up computation for a generalized tree pattern query.

17. The method of claim 16, comprising providing an early result enumeration scheme when elements in a top branch node's top-down stack have been popped out.

18. A method to provide an encoding scheme to replace the hierarchical stack by using a list of matching trees.

19. The method of claim 18, wherein the encoding scheme comprises matching tree encodings.

20. The method of claim 18, comprising creating a compact matching tree encodings through a hybrid of top-down and bottom-up computations.

21. The method of claim 20, comprising associating one or more child matching tables and one descendant matching table for each element in the top-down stack.

22. The method of claim 20, comprising propagating the matching tree encodings to one of: a parent element child matching table, a descendant matching table.
